(19) United States
(12) Patent Application Publication
(10) Pub. No.: US 2011/0252652 A1
(43) Pub. Date: Oct. 20, 2011

(54) Circular Saw with Anti-Splinter Device

(75) Inventors: Bo Zhen, Hangzhou (CN); Aigui Wang, Hangzhou (CN)

(73) Assignees: Robert Bosch GmbH, Stuttgart (DE); Bosch Power Tools (China) Co., Ltd., Hangzhou, Zhejiang (CN)

(21) Appl. No.: 13/140,366

(22) PCT Filed: Dec. 17, 2008
(86) PCT No.: PCT/CN2008/073551

§ 371 Date: Jun. 16, 2011

(51) Int. Cl. B27G 19/04; B27B 9/02; B23D 45/16

(52) U.S. Cl. 30/376

(57) ABSTRACT

A circular saw includes a base plate defining a base plane, a bevel bracket which supports a circular saw blade and is pivotally mounted on the base plate for tilting the blade, the bevel bracket having a pivoting axis which is parallel to the base plane and the blade and perpendicular to a rotational axis of the blade, and the blade partly extending through an opening forming in the base plate, and an anti-splinter device for preventing cutting chips from splintering. The anti-splinter device comprises a pair of slides mounted in the opening and forming a gap between their opposing ends, an outcoming section of the blade passing through the gap, and slide driving means associated with the bevel bracket and driving the slides to move in conformity with the tilting of the blade to allow the gap to accommodate the positional change of the outcoming section of the blade.

### TECHNICAL FIELD

The present invention relates to a circular saw with an improved anti-splinter device for preventing chip splintering during the operation of the saw.

### BACKGROUND ART

Chip splintering happens during the operation of a circular saw. While the saw blade cuts into a workpiece, chips of the workpiece will be engaged by the saw blade and splinter out from the workpiece. Due to the rotation direction of the saw blade, the splintered chips will fly to the operator and sometimes may hurt the operator.

Currently, there are a few structures in the market for preventing chip splintering on the circular saw. One solution is a fixed anti-splinter structure which forms a gap through which the saw blade passes through. The gap is narrow for preventing the chips from splashing between the saw blade and the anti-splinter structure. This anti-splinter structure is effective for straight cutting operation where the saw blade is in a normal vertical orientation. However, when the saw is used for bevel cutting where the saw blade cuts a workpiece in an oblique orientation (the saw blade tilts a certain angle from its normal vertical orientation), the distance between the anti-splinter structure and the blade decreases due to orientation change of the blade. In this condition, there is a danger that the blades contacts with the anti-splinter structure, which may result in a malfunction of the saw. To avoid such contact, the gap needs to be widened, which will, however, lower down the anti-splinter function of the anti-splinter structure.

### SUMMARY OF INVENTION

An object of the present invention is to provide a circular saw with an improved anti-splinter device for preventing chip splintering during the operation of the saw and providing a safe and comfortable working environment to operators.

For achieving this task, according to one aspect of the invention, a circular saw comprises a base plate defining a base plane; a bevel bracket which supports a circular saw blade and is pivotably mounted on the base plate for tilting the blade, the bevel bracket having a pivoting axis which is substantially parallel to the base plane and the blade and substantially perpendicular to a rotational axis of the blade, and the blade partly extending through an opening formed in the base plate; and an anti-splinter device for preventing cutting chips from splintering out of the opening during the operation of the saw and comprising: a pair of slides mounted in the opening and forming a gap between their opposing ends, an outcoming section of the blade passing through the gap; and slide driving means associated with the bevel bracket and driving the slides to move in the base plane in conformity with the tilting of the blade to allow the gap to accommodate the positional change the outcoming section of the blade.

In a preferred embodiment, at least one of the opposing ends of the slides is formed with a slanted portion facing toward the blade.

In a preferred embodiment, the anti-splinter device further comprises guide members attached to the base plate for guiding the movement of the slides.

In a preferred embodiment, the slide driving means comprises a cam plate fixed to the bevel bracket at the pivoting axis, cam slots are formed through the cam plate on opposites sides of the pivoting axis, and the slides are each formed with a protrusion inserted into a corresponding cam slot.

In a preferred embodiment, each of the cam slots extends from an upper end to a lower end, and the distance between the cam slots increases as they extending downwardly.

In a preferred embodiment, the slide driving means comprises a cam which drives one of the slides to move in one direction and a returning means which drives the one of the slides to move in reverse direction, the slides being coupled with each other via a connecting means.

In a preferred embodiment, the slide driving means comprises a sleeve fixed to the bevel bracket at the pivoting axis and a sliding lever slidably inserted through the sleeve and connected with the slides.

In a preferred embodiment, the slide driving means comprises a bar-linkage which is coupled between the bevel bracket and one of the slides, the slides being coupled with each other via a connecting means.

Alternatively, the slide driving means comprises a pair of bar-linkages each coupled between the bevel bracket and a corresponding one of the slides. In a preferred embodiment, the bar-linkages drive the slides in a way that their moving velocities are different from each other.

According to the invention, as the saw blade changes its orientation, the anti-splinter slides move accordingly so as to keep small distances between the slides and the blade. Thus, the anti-splinter device of the circular saw always effectively prevents the chips from splashing from the workpiece as well as ensures a clear line of sight and convenient working condition for operators. Further, by providing the anti-splinter slides near the cutting area, the cutting quality can be improved. The circular saw of the invention can be effectively used for both straight cutting and bevel cutting.

### BRIEF DESCRIPTION OF THE DRAWINGS

The foregoing and other aspects of the invention will be understood and appreciated more fully from the following detailed description taken in conjunction with the following drawings, in which:

FIG. 1 is a top perspective view of a circular saw according to an embodiment of the invention;

FIGS. 2 and 3 are bottom perspective view of the circular saw of FIG. 1, taken in different view angles;

FIG. 4 is a front view of an anti-splinter device adopted in the circular saw of FIG. 1;

FIG. 5 is a perspective view of a cam plate of the anti-splinter device of FIG. 4;

FIG. 6 is a perspective view of anti-splinter slides of the anti-splinter device of FIG. 4;

FIG. 7 is a front view similar to FIG. 4 showing the movements of the cam plate and the anti-splinter slides;

FIG. 8 is a front view similar to FIG. 4 showing chip flows during the cutting operation of the saw of the invention;

FIG. 9 is a front view of another embodiment of the anti-splinter device;

FIG. 10 is a front view of yet another embodiment of the anti-splinter device; and

FIG. 11 is a front view of yet another embodiment of the anti-splinter device.

### DETAILED DESCRIPTION OF THE PREFERRED EMBODIMENTS

Now the preferred embodiments of the circular saw and its anti-splinter device according to the invention will be described with reference to the drawings.

In this description, the term “workpiece” refers to a block of any cuttable material, such as wood, plastic material, glass, metal, or the like.

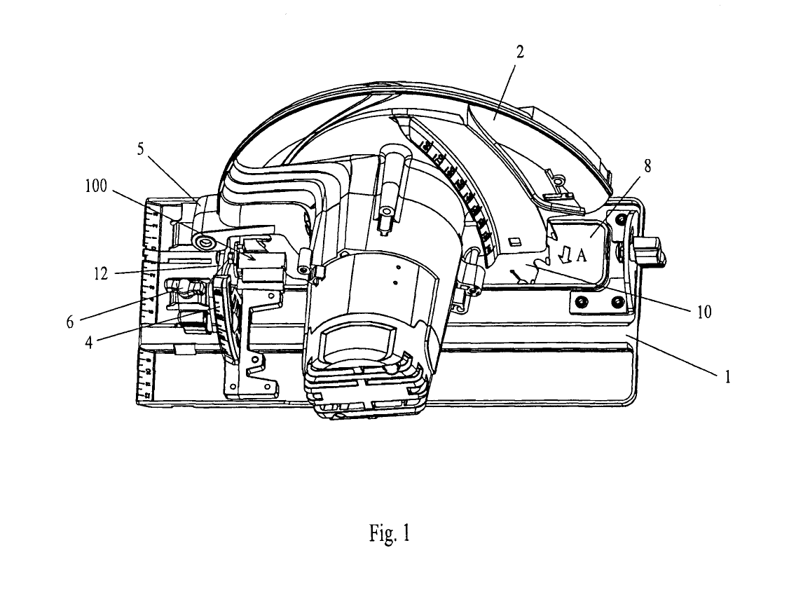

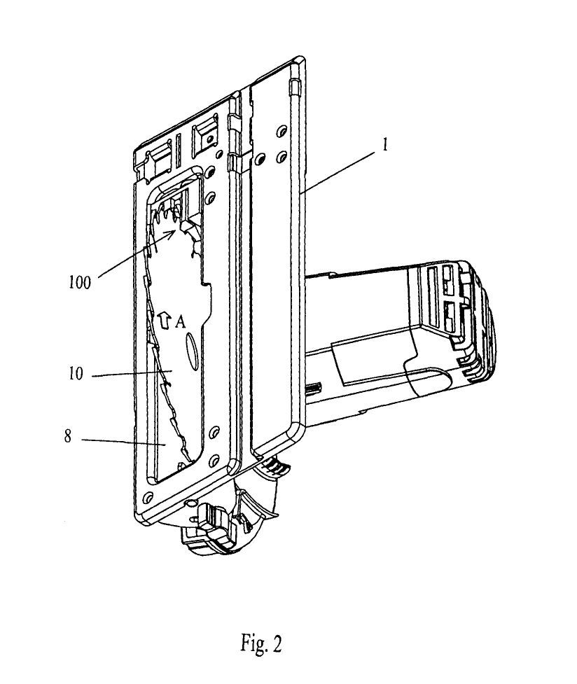

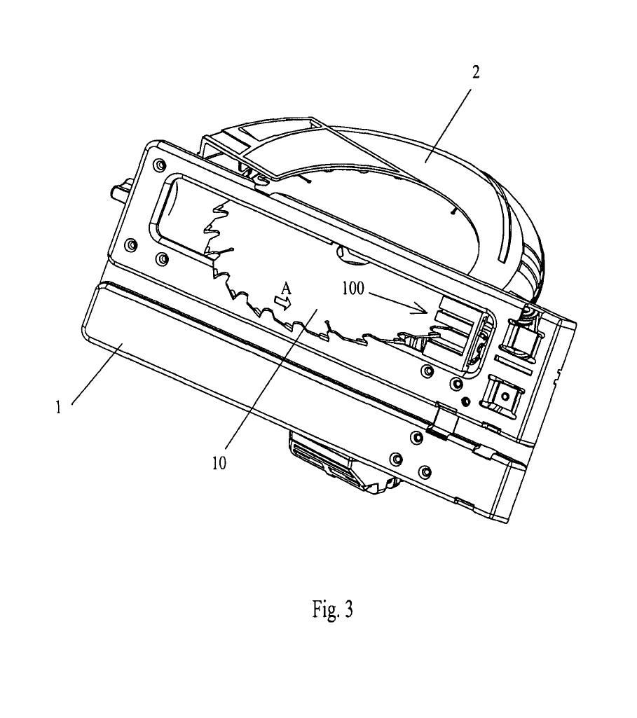

FIGS. 1 to 3 show a circular saw according to an embodiment of the invention. The circular saw comprises a base plate 1 which has a generally flat shape and thus defines a base plane. The base plate 1 will be put on a surface of the workpiece to perform a cutting operation. A bevel bracket 12 is pivotable supported by the base plate 1, and a casing 2 is pivotable supported by the bevel bracket 12 via a pivoting joint 5. The casing 2 carries a rotary motor (not shown) and a circular saw blade 10 driven in rotation by the motor. A outcoming section of the blade 10, which is to be cut into a workpiece, extends through an elongated opening 8 formed in the base plate 1. The pivoting axis of the pivoting joint 5 is perpendicular to the blade 10, so that the casing 2, together with the motor and the blade 10, is pivotable with respect to the bevel bracket 12 to set or change the cutting depth of the blade 10.

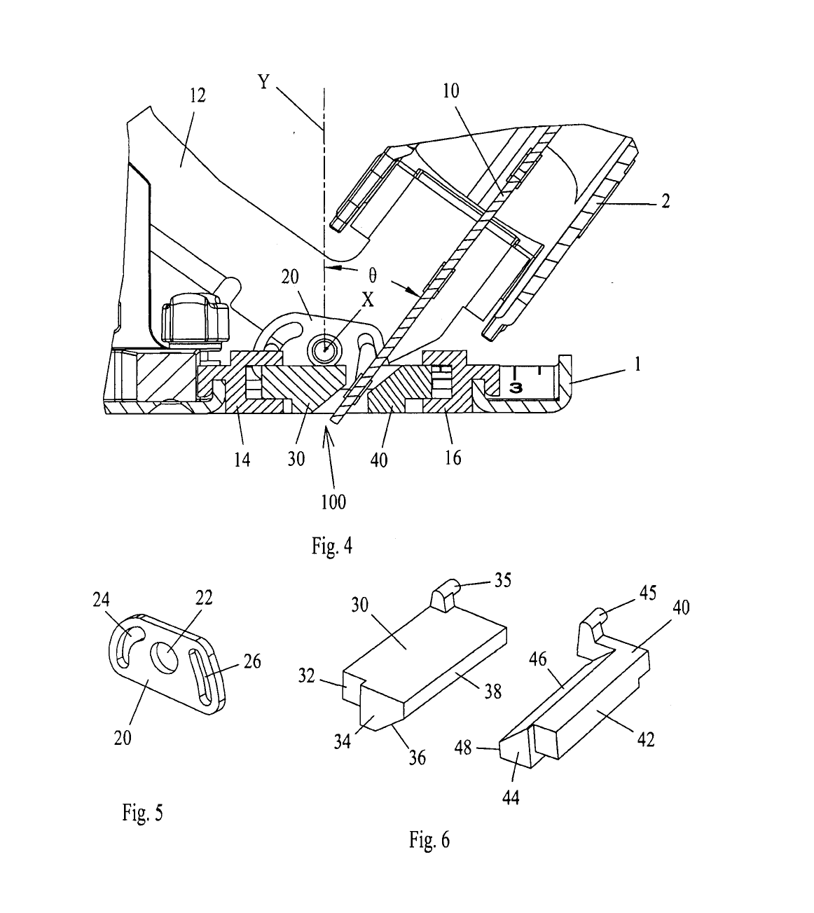

The casing 2, together with the motor and the blade 10, is also pivotable with respect to the base plate 1 around a pivoting axis X (FIG. 4) to adjust the orientation of the blade 10. The pivoting axis X is located near the base plate 1, substantially parallel to the base plane and the blade 10 and substantially perpendicular to the rotational axis of the blade 10. Tilting scale 4 indicates the pivoting angle of the bevel bracket 12 (i.e., the tilting angle of the blade 10). Fastening means 6 releasably fixes the bevel bracket 12 to a desired pivoting position, and thus fixes the tilting angle of the blade 10.

By adjusting the orientation of the blade 10, the cutting angle between the blade 10 and the workpiece can be set. Vertical orientation of the blade 10, which corresponds to, for example, 0° of tilting angle indicated on tilting scale 4, is set for straight cutting, which means that the blade vertically cuts into a workpiece. Tilted orientation of the blade 10, which corresponds to a tilting angle indicated on tilting scale 4 larger than 0°, is set for bevel cutting, which means that the blade obliquely cuts into a workpiece.

During cutting operation of the saw, the blade 10 rotates in a direction shown by arrow “A” in FIGS. 1 to 3. At the outcoming section of the blade 10 where the blade 10 rotates out from the base plate 1, cutting chips move out from the workpiece and fly up. In order to prevent the chips from splintering out of the base plate 1, or reduce the speed of the chips which are flowing out of the base plate 1, an anti-splinter device 100 is arranged about the outcoming section of the blade 10.

FIG. 4 shows the details of the anti-splinter device 100 according to an embodiment of the invention. The anti-splinter device 100 is mounted near one longitudinal end (mounting end) of the elongated opening 8 of the base plate 1 and mainly comprises a cam plate (slide driving means) 20, left and right guide members 14 and 16 and left and right anti-splinter slides 30 and 40, all of which will be described below.

By pivoting the bevel bracket 12, the blade 10 reaches an oblique orientation which forms a tilting angle θ with a vertical plane Y passing through the pivoting axis X. The bevel bracket 12 is pivotable in a direction so that the tilting angle θ of the blade 10 changes from 0° to a certain degree as well as in a reverse direction so that the tilting angle θ of the blade 10 returns to 0°.

The terms “left and right” used here are defined when viewing the anti-splinter device 100 in a direction from another longitudinal end of the elongated opening 8 toward the mounting end of the elongated opening 8. In the normal vertical orientation, the blade 10 is parallel to the vertical plane Y. For bevel cutting, the blade 10 pivots in clockwise direction in FIG. 4 from its normal vertical orientation to an oblique orientation through the tilting angle θ.

The cam plate 20 is fixed to the bevel bracket 12 and has a narrower top side and a wider bottom side. As shown in FIG. 5, a central hole 22 is formed through the cam plate 20 for inserting a screw through it to fix the cam plate 20 to the bevel bracket 12. The pivoting axis X of the bevel bracket 12 (also of the blade 10) coincides with the central axis of the central hole 22. Left and right cam slots 24 and 26 are formed through the cam plate 20 and extending between the top and bottom sides of the cam plate 20. The cam slots 24 and 26 are symmetrical to each other with respect to a symmetrical line extending through the center of the central hole 22. Each of the cam slots 24 and 26 is formed in a way that the distance between it and the symmetrical line increases as it extends from its upper end to its lower end. That is to say, the lower ends of the cam slots 24 and 26 are spaced apart longer than their upper ends.

The left and right guide members 14 and 16 are mounted in the elongated opening 8 at their outer portions. For example, as shown in FIG. 4, there are engaging structures formed on the edges of the base plate 1 which delimit the elongated opening 8 and the adjoining outer portions of the guide members 14 and 16 respectively, so that the guide members 14 and 16 are engaged with and thus fixed to the edges of the base plate 1. Other mounting methods, such as by screw, can be used for mounting the guide members 14 and 16 to the base plate 1. The inner portions of the guide members 14 and 16 are each formed with a guiding structure for guiding a corresponding one of the slides 30 and 40 to move in a left-right direction in the base plane.

The left and right slides 30 and 40 are movably mounted to the left and right guide members 14 and 16 respectively. To this end, the outer portions 32 and 42 of the slides 30 and 40 are formed with guided structures which will be guided by the guiding structures of the guide members 14 and 16 respectively. In the embodiment shown in FIG. 4, rectangular guiding slots are opened into the inner portions of the guide members 14 and 16, and rectangular guided blocks are formed as the outer portions of the slides 30 and 40 and slidably inserted into the guiding slots of the guide members 14 and 16 respectively. However, other guiding structures known in the art may be used for guiding the movements of the slides 30 and 40.

The slides 30 and 40 are movable under the guide of the guide members 14 and 16 in the left-right direction, which direction being perpendicular to the pivoting axis X (the central axis of the central hole 22) and parallel to the base plane.

When mounted to the guide members 14 and 16, a gap is formed between the opposing ends of the slides 30 and 40 which face each other.

As shown in FIG. 6, the inner portion 34 (right portion) of the left slide 30 comprises a vertical upper portion 38 and an slanted lower portion 36 which forms a surface facing toward the lower-right direction, and the inner portion 44 (left portion) of the right slide 40 comprises a vertical lower portion 48 and an slanted upper portion 46 which forms a surface facing toward the upper-left direction. When the slides 30 and 40 are assembled, the vertical upper portion 38 and the slanted lower portion 36 oppose to the slanted upper portion 46 and the vertical lower portion 48 respectively, with the above mentioned gap formed therebetween.

The slides 30 and 40 are each formed with a cylindrical protrusion 35 or 45 at their rear ends. In the assembled state of the slides 30 and 40, their protrusions 35 and 45 insert into the cam slots 24 and 26 respectively, so that, under the camming action of the cam slots 24 and 26, the protrusions 35 and 45 drive the slides 30 and 40 to move with respect to the base plate 1 under the guide of the guide members 14 and 16.

The cam plate 20 is fixed to the bevel bracket 12 in an orientation such that, in the normal vertical orientation of the blade 10, the protrusion 35 of the left slide 30 inserts in the left cam slot 24 near the upper end of the left cam slot 24, the protrusion 45 of the right slide 40 inserts in the right cam slot 26 near the lower end of the right cam slot 26, and the slides 30 and 40 are in their right-most position.

The protrusions 35 and 45 are formed on the slides 30 and 40 in such locations that, when the slides 30 and 40 are assembled in place, the outcoming section of the blade 10 can pass through the gap formed between the slides 30 and 40.

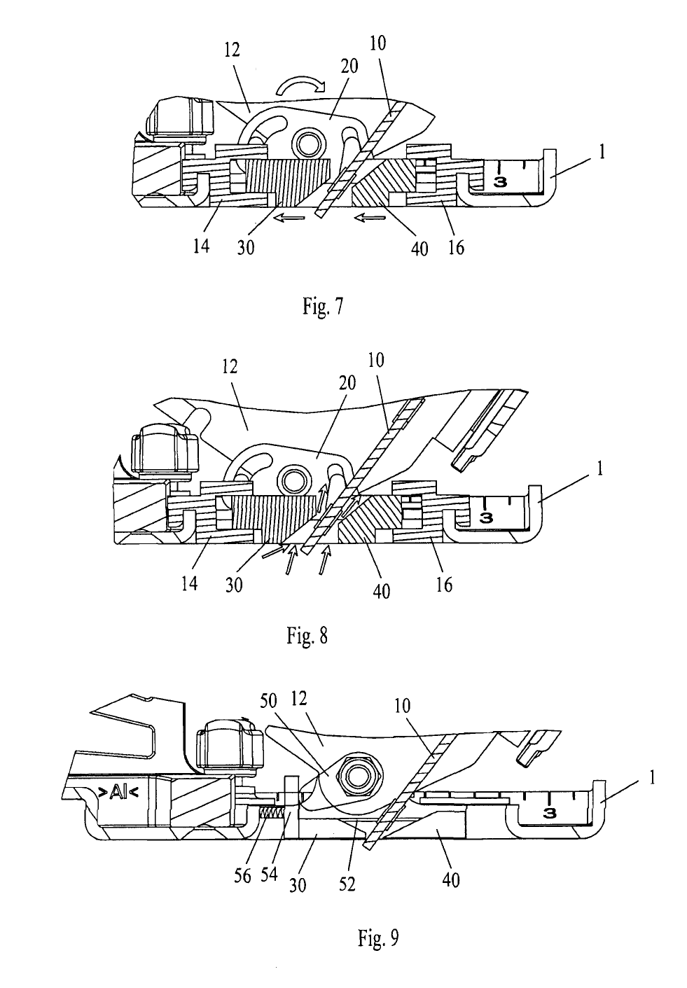

When the bevel bracket 12 and blade 10 pivot around the pivoting axis X (the central axis of the central hole 22) for reaching the tilting angle θ of the blade 10 from its vertical orientation (in a clockwise direction in FIG. 4), the protrusion 35 moves in the left cam slot 24 toward the lower end of it while the protrusion 45 moves in the right cam slot 26 toward the upper end of it. Since each of the cam slots 24 and 26 is formed in a way that the distance between it and the symmetrical line increases as it extends from its upper end to its lower end as described above, the movements of the protrusions 35 and 45 in the cam slots 24 and 26 cause the slides 30 and 40 move to the left, as shown in FIG. 7.

It can be understood that, when the bevel bracket 12 pivots to return the blade 10 back to its vertical orientation (in an anti-clockwise direction in FIG. 4), the slides 30 and 40 move in a reverse manner, that is, to the right.

Thanks to the slanted lower portion 36 of the left slide 30 and the slanted upper portion 46 of the right slide 40, in the oblique orientation of the blade 10, there are still narrow but enough distances between the blade and the slides 30 and 40 without contacting between them. During bevel cutting operation of the saw, chips will flow through the gap between the opposing ends of the slides 30 and 40, but the flowing directions of the ships will change, as shown by the arrows in FIG. 8, and flowing speed of the chips will be reduced, which help to prevent the chips from splintering toward the operator.

The above embodiments describe a slide driving means formed by a cam plate with double cam slots for driving the slides. Other slide driving means for driving the slides moving in the same direction can also be used in the anti-splinter device of the invention. FIGS. 9-11 show some embodiments of the slide driving means.

FIG. 9 shows a single cam design of the anti-splinter device in which a single cam 50 is fixed to the bevel bracket 12 at the pivoting axis X of the bevel bracket 12 and the blade 10, and thus is pivotable around the pivoting axis X together with the bevel bracket 12 and the blade 10 for driving the left and right slides 30 and 40. Opposing ends of the left and right slides 30 and 40 each has a slanted portion facing to the upper-inner direction. The saw blade 10 inserts through the gap formed between the opposing ends of the slides 30 and 40. The tip end of the cam 50, which forms a cam surface, abuts against the inner side of a vertical abutting portion 54 of the left slide 30. The slides 30 and 40 are coupled with each other via a connecting means 52, for example a connection bar, so as to be move jointly with each other.

When the bevel bracket 12 pivots for reaching the tilting angle θ of the blade 10 from its vertical orientation, the cam 50 pushes the left slide 30 to move to the left, and the right slide 40 follows the movement of the left slide 30 by means of the connecting means 52. A returning means is provided for moving the slides 30 and 40 to the right when the bevel bracket 12 pivots for returning the blade 10 back to its vertical orientation. For example, the returning means may be a compression spring 56 disposed between a portion of the base plate 1 and the outer side of the abutting portion 54.

In the embodiment shown in FIG. 9, the abutting portion 54 is formed on the left slide 30, and the cam 50 and the spring 56 drive the slides to move to the left and right respectively. It can be understood that, however, the abutting portion 54 may be formed on the right slide 40, and the cam 50 and the spring 56 drive the slides to move to the right and left respectively.

Alternatively, the spring 56 may be an extension spring for achieving the same function. Still alternatively, the returning means may be formed by other elastic materials or other mechanisms.

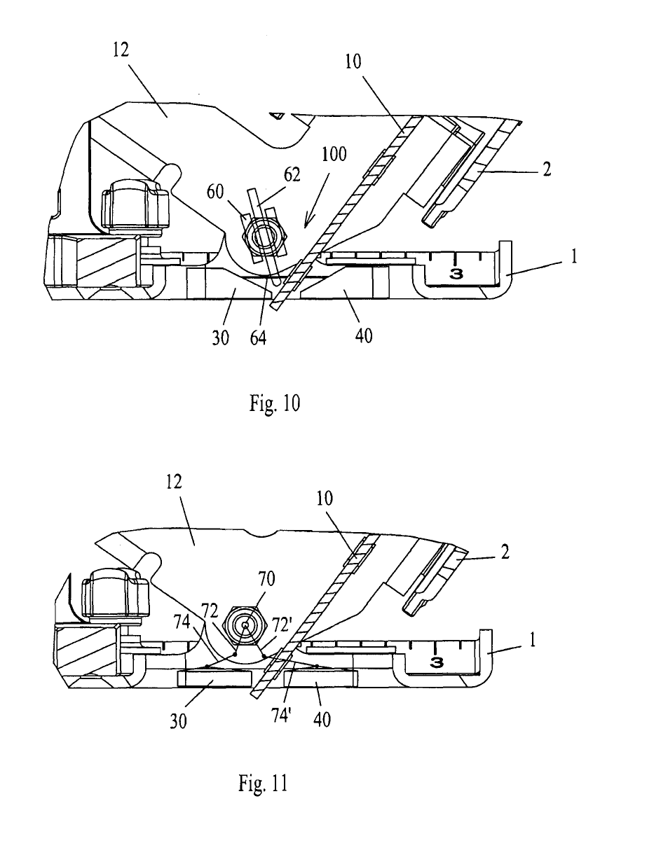

FIG. 10 shows a sliding lever design of the anti-splinter device in which a sleeve 60 is fixed to the bevel bracket 12 at the pivoting axis X of the bevel bracket 12 and the blade 10, and thus is pivotable around the pivoting axis X together with the bevel bracket 12 and the blade 10. A sliding lever 62 is slidably inserted through the sleeve 60. When the sleeve 60 pivots along with the bevel bracket 12, the sliding lever 62 pivots along with the sleeve 60 and slides in the sleeve 60. Left and right slides 30 and 40 are coupled with each other via a connecting means 64, for example a connection bar, so as to be move jointly with each other. Opposing ends of the left and right slides 30 and 40 each has a slanted portion facing to the upper-inner direction. The lower end of the sliding lever 62 is operatively connected with the connecting means 64, so that, when the sliding lever 62 pivots, the sliding lever 62 drives the slides 30 and 40 to move to the left or right via the connecting means 64.

FIG. 11 shows a bar-linkage design of the anti-splinter device in which a pivot shaft 70 is fixed to the bevel bracket 12 at the pivoting axis X of the bevel bracket 12 and the blade 10, and thus is rotatable around the pivoting axis X together with the bevel bracket 12 and the blade 10. The pivot shaft 70 is couple with each of the left and right slides 30 and 40 via a bar-linkage. Specifically, each bar-linkage comprises an active bar 72 (72′) which has one end that is fixed to the pivot shaft 70 and another end that is hinged to a first end of a link bar 74 (74′). A second end of the link bar 74 (74′) is hinged to the slide 30 (40). Thus, when the bevel bracket 12 pivots in clockwise direction, the bar-linkages drives the left and right slides 30 and 40 to move to the lift, and when the bevel bracket 12 pivots in anti-clockwise direction, the bar-linkages drives the left and right slides 30 and 40 to move to the right. Opposing ends of the left and right slides 30 and 40 are both straight vertical ends.

Alternatively, only one of the left and right slides 30 and 40 is coupled with the pivot shaft 70 via a bar-linkage, and the slides 30 and 40 are coupled with each other via a connecting means.

It is appreciated that, by choosing the lengths of the bars 72, 72′, 74 and 74′, the moving velocities of the left and right slides 30 and 40 can be set as desired. For example, the moving velocities of the left and right slides 30 and 40 may be substantially equal to each other, so that the width of the gap between them can be kept substantially constant. Alternatively, when the left and right slides 30 and 40 are moving to the left, the moving velocity of the left slide 30 may be a little higher than that of the right slide 40, so that the width of the gap between them increases to accommodate the increasing tilting angle of the blade 10.

In all the embodiments described above, when the saw blade pivots (tilts), the slides of the anti-splinter device follow the tilting motion of the blade to move in conformity with the outcoming section of the blade, thus keeping small distances between the slides and the blade to prevent the chips from splashing from the workpiece as well as ensures a clear line of sight and convenient working condition for operators. Further, by providing the anti-splinter slides near the cutting area, the cutting quality can be improved.

1. A circular saw comprising:
a base plate defining a base plane;
a bevel bracket which supports a circular saw blade and is pivotably mounted on the base plate for tilting the blade, the bevel bracket having a pivoting axis which is substantially parallel to the base plane and the blade and substantially perpendicular to a rotational axis of the blade, and the blade partly extending through an opening formed in the base plate; and
an anti-splinter device configured to prevent cutting chips from splintering out of the opening during operation of the saw, said anti-splinter device comprising:
a pair of slides mounted in the opening and forming a gap between their opposing ends, an outcoming section of the blade passing through the gap; and
slide driving means associated with the bevel bracket and driving the slides to move in the base plane in conformity with the tilting of the blade to allow the gap to accommodate the positional change the outcoming section of the blade.

2. The circular saw according to claim 1, wherein at least one of the opposing ends of the slides is formed with a slanted portion facing toward the blade.

3. The circular saw according to claim 1, wherein the anti-splinter device further comprises guide members attached to the base plate configured to guide movement of the slides.

4. The circular saw according to claim 1, wherein the slide driving means comprises a cam plate fixed to the bevel bracket at the pivoting axis, with cam slots formed through the cam plate on opposites sides of the pivoting axis, and the slides are each formed with a protrusion inserted into a corresponding cam slot.

5. The circular saw according to claim 4, wherein each of the cam slots extends from an upper end to a lower end, and the distance between the cam slots increases as they extending downwardly.

6. The circular saw according to claim 1, wherein the slide driving means comprises a cam which drives one of the slides to move in one direction and a returning means which drives the one of the slides to move in reverse direction, the slides being coupled with each other via a connecting means.

7. The circular saw according to claim 1, wherein the slide driving means comprises a sleeve fixed to the bevel bracket at the pivoting axis and a sliding lever slidably inserted through the sleeve and connected with the slides.

8. The circular saw according to claim 1, wherein the slide driving means comprises a bar-linkage which is coupled between the bevel bracket and one of the slides, the slides being coupled with each other via a connecting means.

9. The circular saw according to claim 1, wherein the slide driving means comprises a pair of bar-linkages each coupled between the bevel bracket and a corresponding one of the slides.

10. The circular saw according to claim 9, wherein the bar-linkages drive the slides in a way that their moving velocities are different from each other.
